(19) United States
(12) Patent Application Publication
(10) Pub. No.: US 2025/0306288 A1
(43) Pub. Date: Oct. 2, 2025

(54) OPTICAL FIBER SWITCHING METHOD

(71) Applicant: NIPPON TELEGRAPH AND TELEPHONE CORPORATION, Tokyo (JP)

(72) Inventors: Hidenobu HIROTA, Musashino-shi, Tokyo (JP); Takui UEMATSU, Musashino-shi, Tokyo (JP); Kazutaka NOTO, Musashino-shi, Tokyo (JP); Hiroyuki IIDA, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/863,003

(22) PCT Filed: May 19, 2022
(86) PCT No.: PCT/JP2022/020844

§ 371 Date: Nov. 5, 2024

(51) Int. Cl. G02B 6/35; H04B 10/079; H04B 10/25

(52) U.S. Cl. CPC G02B 6/3586; H04B 10/07955; H04B 10/25

(57) ABSTRACT

An object of the present disclosure is to reduce a communication stop time that occurs with optical fiber switching.

The present disclosure is an optical fiber switching method for switching a communication partner of a first optical communication device connected to a first optical fiber from a second optical communication device connected to the first optical fiber to a third optical communication device connected to a second optical fiber, the method including: polishing each of side surfaces of the first optical fiber and the second optical fiber to a vicinity of a core; bringing polishing surfaces of the first optical fiber and the second optical fiber close to each other to form an optical coupler that couples the first optical fiber and the second optical fiber; and switching from the first optical fiber to the second optical fiber, using the optical coupler.

### TECHNICAL FIELD

The present disclosure relates to a technique for switching connection of an optical fiber in an optical communication network.

### BACKGROUND ART

In an optical access network, services of Internet and telephone are provided to users. When equipment constituting the optical access network is replaced, switching work of the optical fiber is performed from the originally used equipment to the new equipment. Although an optical fiber of a transfer source was used for communication, in the switching work of the optical fiber, communication was stopped during the construction period to cut the optical fiber and perform fusion splicing or the like (see, for example, NPL 2)

### CITATION LIST

### Non Patent Literature

[NPL 1] Tomohiro Onuma, Akihito Nishimura, Shoichiro Matsuo, Kuniharu Himeno, “Basics and latest technology of optical fiber connections for communication,” Laser Research, 2012, Vol. 40, No. 6, p. 435

### SUMMARY OF INVENTION

### Technical Problem

An object of the present disclosure is to reduce a communication stop time that occurs with optical fiber switching.

### Solution to Problem

An optical fiber switching method according to the present disclosure is
an optical fiber switching method for switching a communication partner of a first optical communication device connected to a first optical fiber from a second optical communication device connected to the first optical fiber to a third optical communication device connected to a second optical fiber, the method including:
polishing each of side surfaces of the first optical fiber and the second optical fiber to a vicinity of a core;
bringing polishing surfaces of the first optical fiber and the second optical fiber close to each other to form an optical coupler that couples the first optical fiber and the second optical fiber; and
switching from the second optical communication device to the third optical communication device using the optical coupler.

In the present disclosure, since the optical coupler is configured by using the first optical fiber and the second optical fiber, and the first optical communication device and the third optical communication device are connected by using the optical coupler, the second optical communication device can be switched to the third optical communication device without cutting the first optical fiber. Therefore, the present disclosure can reduce a communication stop time that occurs with optical fiber switching.

In the present disclosure, the optical coupler may be configured in a state in which the first optical communication device and the second optical communication device maintain communication, and a coupling condition of light in the optical coupler may be adjusted on the basis of optical signals transmitted and received by the first optical communication device and the second optical communication device.

In the present disclosure, the optical signal may be transmitted from the third optical communication device to the first optical communication device after blocking the optical signal transmitted from the second optical communication device.

In the present disclosure, the first optical communication device may compare power of a first optical signal received from the second optical communication device with power of a second optical signal received from the third optical communication device while performing communication between the second optical communication device and the third optical communication device, an instruction of stopping transmission of the optical signal may be transmitted when the power of the second optical signal becomes larger than the power of the first optical signal, and the second optical communication device of the second optical communication device and the third optical communication device that have received the instruction may stop transmission of the optical signal. Here, the first optical communication device may perform communication with the second optical communication device and the third optical communication device using time division multiplex communication.

An optical communication device according to the present disclosure is an optical communication device that functions as the first optical communication device,
the first optical fiber is connected to a second optical fiber connected to a third optical communication device by an optical coupler,
power of a first optical signal received from the second optical communication device is compared with power of a second optical signal received from the third optical communication device while communication between the second optical communication device and the third optical communication device is performed, and
an instruction of stopping transmission of the optical signal is transmitted when the power of the second optical signal becomes larger than the power of the first optical signal.

The above disclosures may be combined where possible.

### Advantageous Effects of Invention

According to the present disclosure, it is possible to reduce a communication stop time that occurs with optical fiber switching.

### BRIEF DESCRIPTION OF DRAWINGS

FIG. 1 is an example of a structure of an optical fiber.

FIG. 2 is an example of the configuration of optical communication.

FIG. 3 is a wiring example of an actual optical fiber.

FIG. 4 is an example of service provision from an OLT installed in a new communication building.

FIG. 5 is an example of a method for cutting an optical fiber.

FIG. 6 shows an example of connection of optical fibers using fusion.

FIG. 7 is an example of switching of optical fibers, with FIG. 7(a) showing the state before switching and FIG. 7(b) showing that after switching.

FIG. 8 shows a schematic configuration of a switching point in the present disclosure.

FIG. 9 shows an example of a method for manufacturing an optical coupler of the present disclosure.

FIG. 10 shows an example of the optical coupler of the present disclosure.

FIG. 11 shows temporal changes in power in which an optical signal of an ONU reaches each OLT.

FIG. 12 is an example of a state in which optical signals output from each OLT during switching overlap.

FIG. 13 is an example of interruption of an optical signal from an OLT#1, with FIG. 13(a) showing a case where the optical fiber is bent and FIG. 13(b) showing a case where the optical fiber is cut.

FIG. 14 is an example of controlling the timing of optical signals that are output from each OLT in an old communication building and a new communication building.

FIG. 15 is an example of changes in an optical signal from ONU#1 and timing control by the optical coupler.

FIG. 16 is an example of power of an optical signal received by the ONU#1.

FIG. 17 is an example of a configuration for monitoring the power of an optical signal in the ONU.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

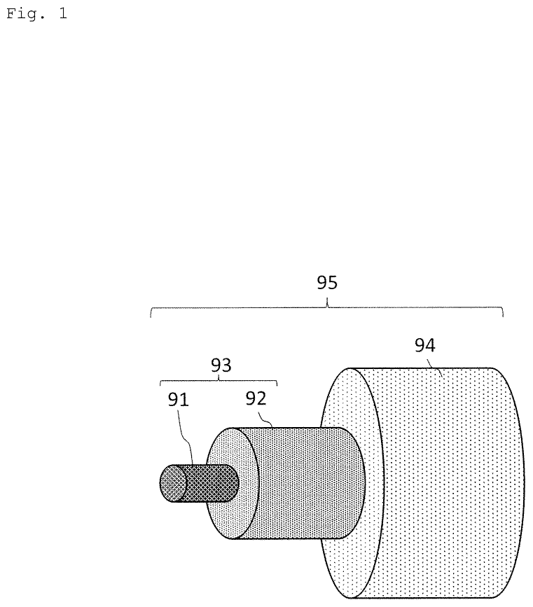

As shown in FIG. 1, an optical fiber 95 has a three-layer structure including a core 91, a clad 92 for covering a periphery thereof, and a covering 94 for protecting the clad 92. The core 91 and the clad 92 may be made of any material, but in the present embodiment, they are made of glass. Hereinafter, a portion made of glass including the core 91 and the clad 92 is referred to as a glass part 93. The core 91 is mainly made up of pure quartz glass, and germanium dioxide is used as an additive. The refractive index is increased by adding germanium dioxide. On the other hand, the clad 92 is designed to have a refractive index lower than that of the core 91 by forming the clad 92 only of pure quartz glass. Since the refractive indexes of the core 91 and the clad 92 are different, total reflection is generated on a boundary surface, and an optical signal is propagated in the core 91.

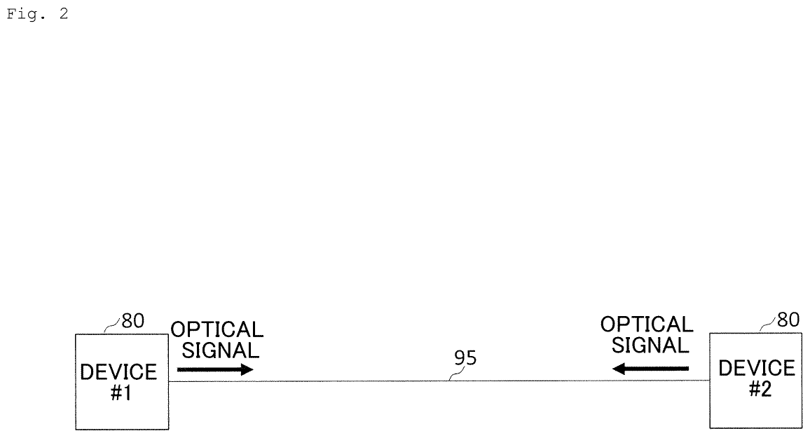

In optical communication, devices 80#1 and 80#2 are installed at both ends of an optical fiber 95 as shown in FIG. 2. Optical communication is performed by outputting an optical signal from the device 80 and recognizing the mutual devices 80 via the optical fiber 95. Services such as the Internet and telephone are provided to the user of the terminal using this principle.

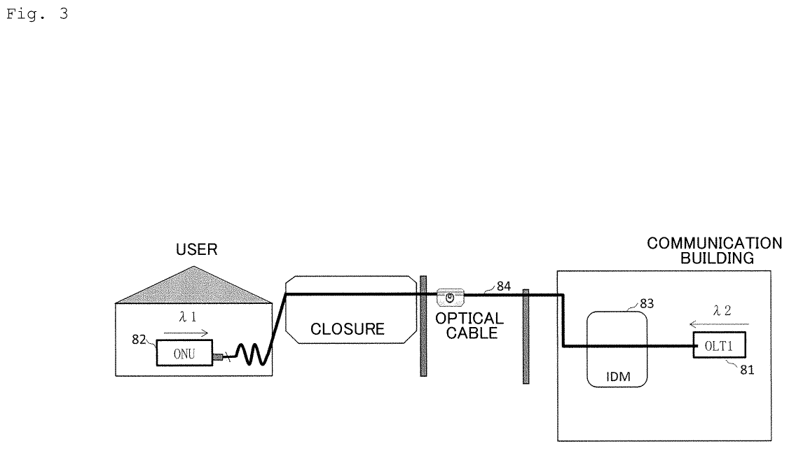

FIG. 3 shows a wiring example of an actual optical fiber. FIG. 3 is a diagram showing a wiring configuration for providing services. An optical line terminal (OLT) 81 is installed in a communication building, and an optical network unit (ONU) 82 is installed in a terminal of a user. The OLT 81 and the ONU 82 correspond to devices 80#1 and 80#2. Optical signals output from the OLT 81 and the ONU 82 have different wavelengths. In the present disclosure, a wavelength output from the ONU 82#1 is defined as a wavelength λ1, and a wavelength output from the OLT 81#1 is defined as a wavelength λ2. In the present embodiment, an example is shown in which an integrated distribution module (IDM) 83 and an optical cable 84 in which a plurality of optical fibers 95 are bundled are interposed in the communication building to connect the OLT 81 and the ONU 82.

The communication building itself is deteriorated by the passage of time after the building is constructed. For example, as an event, concrete cracks and moisture enters from the crack. In the building, the OLT 81 and electric devices are installed in a large amount, and the entry of moisture may affect the electric device, and in the worst case, it is conceivable that it may even stop. That is, the service cannot be provided to the user of the terminal.

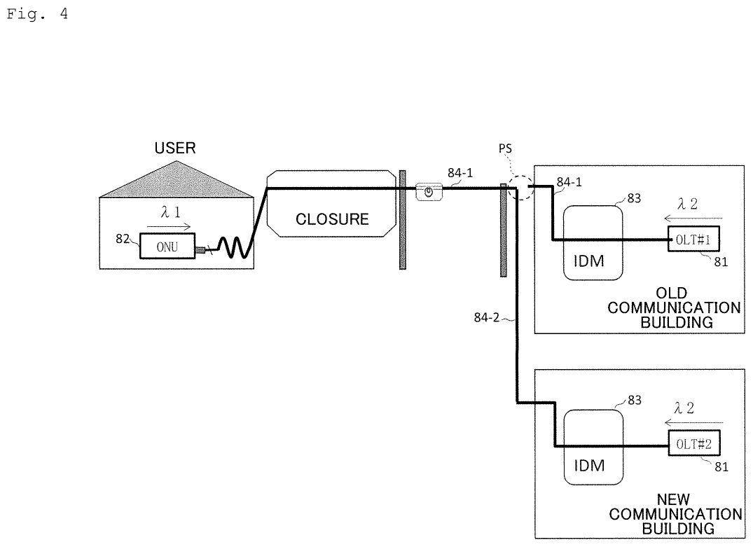

Therefore, as shown in FIG. 4, a new communication building is constructed, and an OLT 81#2 is newly installed in the communication building to provide a service by an optical signal from the OLT 81#2. To this end, it is necessary to switch the optical cable 84-1 to a new optical cable 84-2 anywhere on the optical cable 84-1.

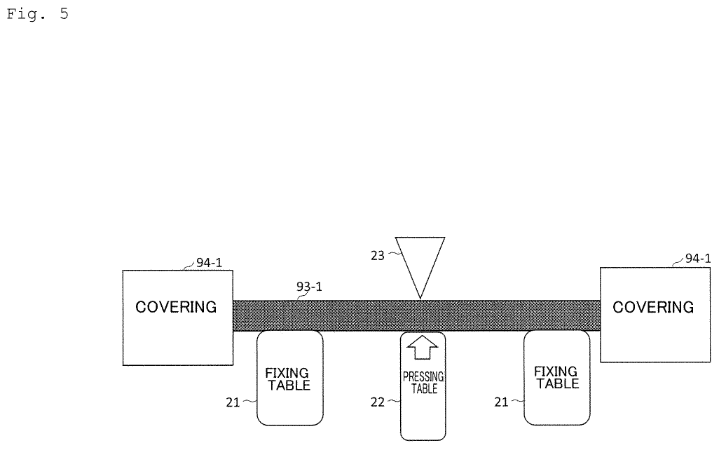

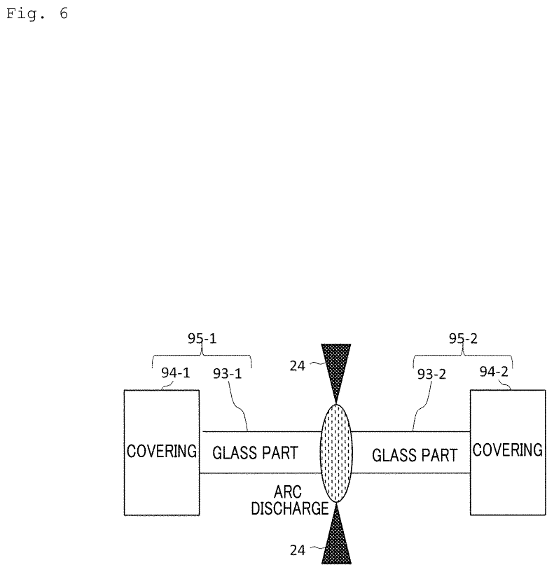

In the current construction method, the optical fiber in the old optical cable 84-1 extending from the old communication building is cut at a switching point PS that the optical cable 84-2 of the optical cable 84-1 can reach, and the optical fiber is connected to the optical fiber of the optical cable 84-2 extending from the new communication building. FIG. 5 shows a cutting process, and FIG. 6 shows a connecting process. The optical fiber included in the optical cable 84-1 is taken out, the covering 94-1 of the optical fiber is removed to expose the glass part 93-1, and both ends of the glass part 93-1 are installed on a fixing table 21. When a pressing table 22 is moved upward from below, the glass part 93-1 of the optical fiber is held between a cutter 23 such as a metal blade and the pressing table 22. By moving the blade of the cutter 23 forward, the blade of the cutter 23 is brought into contact with the glass part 93-1 to scratch the glass part 93-1. Since the pressure from the pressing table 22 is applied, the damaged glass part 93-1 is cracked and the optical fiber in the optical cable 84-1 is cut.

FIG. 6 shows an example of a method of connecting the optical fibers to each other. An optical fiber 95-1 in the optical cable 84-1 and an optical fiber 95-2 in the optical cable 84-2 are disposed opposite to each other, and the cores of the glass parts 93-1 and 93-2 are aligned with high accuracy. Thereafter, discharge is performed from the electrode rod 24 to melt the end faces of the glass parts 93-1 and 93-2 to connect the optical fibers 95-1 and 95-2 to each other (see, for example, NPL 1).

In the current construction, as shown in FIGS. 5 and 6, the optical fiber 95-1 is cut and the optical fibers 95-1 and 95-2 are connected to each other. Since the optical fiber 95-1 is cut, the optical signal propagating in the optical fiber 95-1 stops. The time required for this work, i.e., the time required for stopping the communication, is about 5 minutes to 10 minutes. Therefore, in the present disclosure, in order to reduce the communication stop time, switching of the optical fiber from the old communication building to the new communication building is performed more preferably without stopping the communication.

### First Embodiment

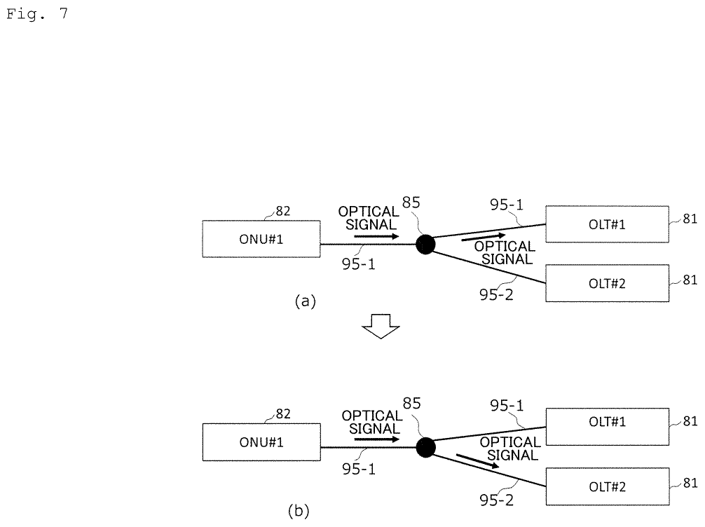

FIG. 7 shows drawings before switching and after switching. In the drawings, an optical signal output from the ONU 82#1 is shown. In the present embodiment, an optical coupler 85 is configured to couple optical fibers 95-1 and 95-2 to the switching point PS, and an optical signal from the ONU 82#1 is switched from the OLT 81#1 to the OLT 81#2 by using the optical coupler 85. The optical coupler combines and branches optical signals.

In the present disclosure, the ONU 82#1 functions as a first optical communication device, the OLT 81#1 functions as a second optical communication device, and the OLT 81#2 functions as a third optical communication device. The optical fiber 95-1 functions as a first optical fiber, and the optical fiber 95-2 functions as a second optical fiber. Although not shown, an optical signal from the OLT 81#1 to the ONU 82#1 functions as a first optical signal, and an optical signal from the OLT 81#2 to the ONU 82#1 functions as a second optical signal.

Specifically, an optical fiber switching method of the present disclosure is an optical fiber switching method for switching a communication partner of the ONU 82#1 connected to the optical fiber 95-1 from the OLT 81#1 connected to 95-1 to the OLT 81#2 connected to the optical fiber 95-2, the side faces of the optical fibers 95-1 and 95-2 are polished to the vicinity of the core 91, an optical coupler 85 for coupling the optical fibers 95-1 and 95-2 is constituted by bringing the polishing surfaces of the optical fibers 95-1 and 95-2 close to each other, and the optical coupler 85 is used to switch from the OLT 81#1 to the OLT 81#2.

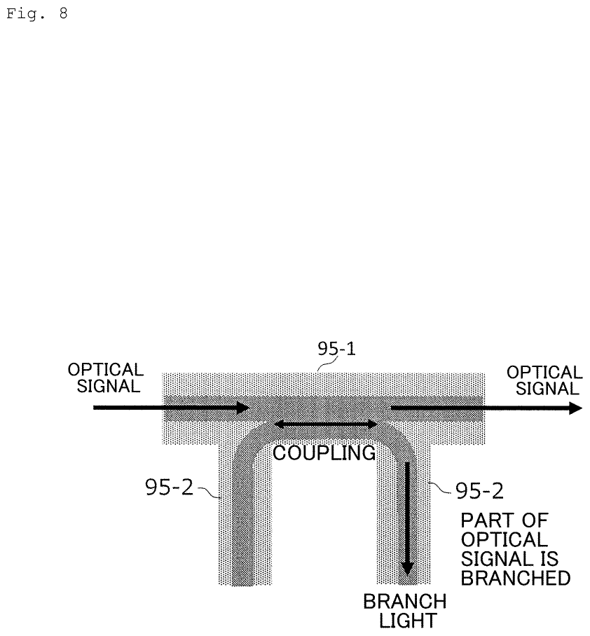

FIG. 8 shows a schematic configuration of the switching point PS in the present disclosure. In the present disclosure, the optical coupler 85 is configured to couple an optical signal propagating through the core of the optical fiber 95-1 to the core of the optical fiber 95-2 at a switching point PS. As described above, in the present disclosure, the optical coupler 85 is formed at the switching point PS, thereby switching the optical signal as shown in FIG. 7.

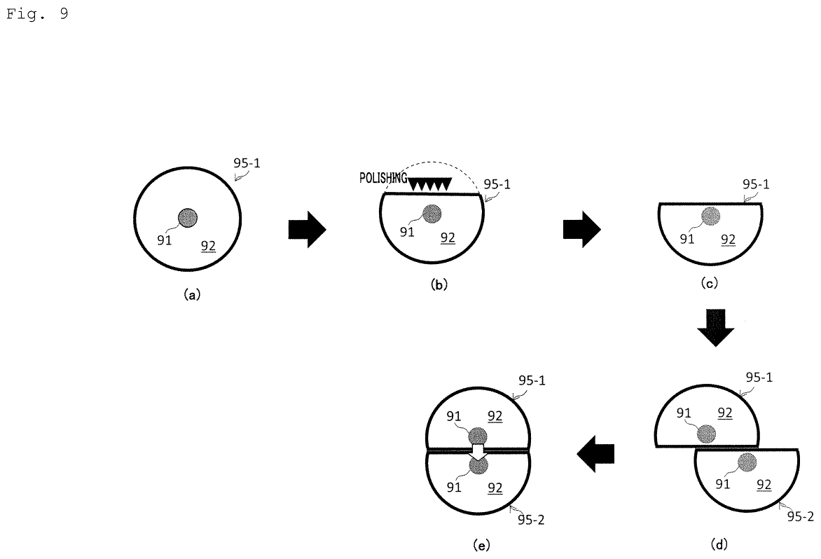

The optical coupler 85 may adopt an arbitrary configuration, but for example, the optical fiber 95-1 is polished from the side surface to form the optical coupler 85. FIG. 1 shows that the optical fiber 95-1 is constituted by the covering 94, the clad 92 and the core 91 from the outside. The ONU 82#1 and the OLT 81#1 maintain communication without disconnecting the communication, and the optical signal propagates inside the core 91 of the optical fiber 95-1. FIG. 9 shows an optical coupler 85 manufactured by polishing the side surface of the optical fiber 95.

FIG. 9 is a cross-sectional view of the side surface processing of the optical fibers 95-1 and 95-2. Although the description of the covering layer is omitted in the drawing (FIG. 9(a)), the covering for covering the optical fiber 95-1 is polished, the clad 92 is further polished (FIG. 9(b)), and the polishing is advanced to the vicinity of the core 91 (FIG. 9(c)). The optical fiber 95-2 is also polished in the same manner as the optical fiber 95-1 (FIG. 9(d)).

Here, the present disclosure is characterized in that the polishing of the optical fibers 95-1 and 95-2 does not reach the core 91. The loss may be evaluated, while an optical signal is input to the optical fiber 95-1 during polishing. In this case, the loss is maintained at 0.5 dB or less. A feature of the present disclosure is that the communication is not interrupted by polishing the optical fiber 95-1.

Further, in the present embodiment, the conditions of light coupling in the optical coupler 85 may be adjusted, on the basis of the optical signals transmitted and received by the OLT 81#1 and 81#2. For example, the power of an optical signal transmitted from the ONU 82#1 is measured by optical fibers 95-1 and 95-2 after branching by the optical coupler 85. This measurement can be performed by curving the optical fibers 95-1 and 95-2 and using the leaked light from the curved part.

When the positions of the polished optical fibers 95-1 and 95-2 are adjusted (FIG. 9(d)) and aligned (FIG. 9(e)), the optical signal propagating through the core 91 of the optical fiber 95-1 can be transferred to the core 91 of the optical fiber 95-2. By adjusting the positions of the optical fibers 95-1 and 95-2, the conditions for coupling the optical fibers 95-1 and 95-2 can be adjusted.

Here, the coupling conditions are determined by a distance in a longitudinal direction in the state shown in FIG. 9(e), a distance between the two cores 91, and the like. Calculation can be performed, by using the coupling condition as a parameter. Although a part of the optical signal is propagated to the side of the fiber 95-2 as branched light, by changing the coupling condition, 100% of the power of the optical signal of the optical fiber 95-1 can be transferred to the optical fiber 95-2, and half of the power of the optical signal of the optical fiber 95-1 can be transferred to the optical fiber 95-2.

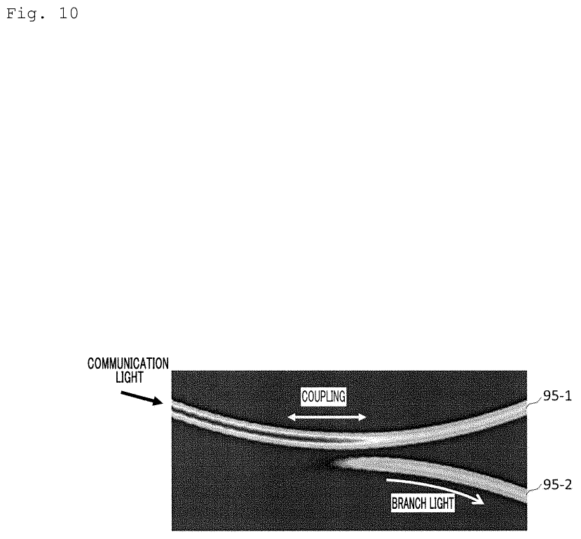

FIG. 10 shows an example of the result of calculation of the branching in the optical coupler 85. It is understood that a part of the optical signal propagating through the core of the optical fiber 95-1 is transferred to the core of the optical fiber 95-2 by sticking two optical fibers after polishing and adjusting the position. As described above, the amount of power transferred from the optical fiber 95-1 to the optical fiber 95-2 is determined by the coupling conditions.

### Second Embodiment

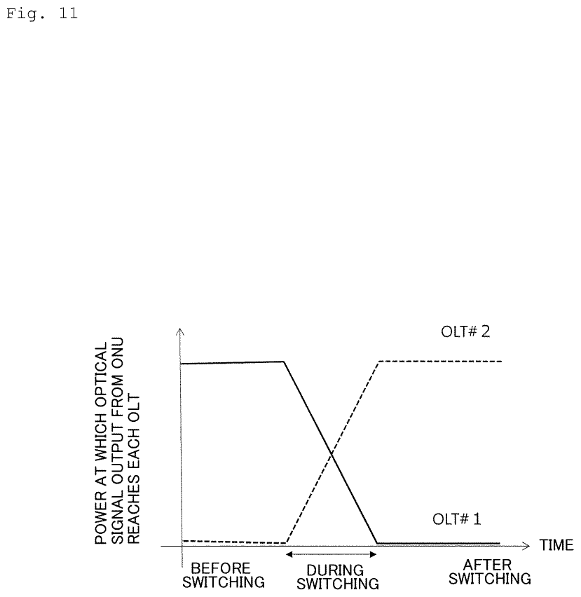

FIG. 11 shows a change in time when the optical signal from the ONU 82 reaches each of the OLT 81#1 and 81#2. A horizontal axis indicates a time axis before switching, during switching, and after switching, and a vertical axis indicates a power at which the optical signal output from the ONU 1 reaches each OLT. As shown in FIG. 11, when the two fiber cores 91 approach each other, the power is shifted.

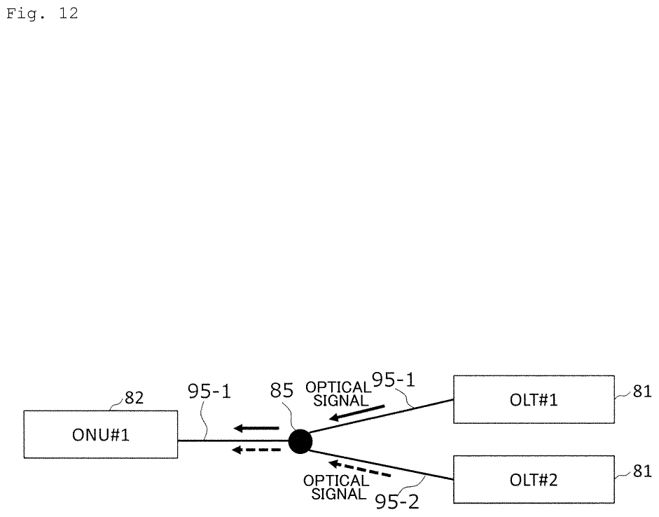

In the present disclosure, since there are two OLT 81, when optical signals are transmitted from both the OLT 81#1 and the OLT 81#2 during switching, the optical signals of the OLT 81#1 and the OLT 81#2 overlap each other as shown in FIG. 12. When two signals of the OLT 81#1 and the OLT 81#2 reach the ONU 82#1 in an overlapping manner, since the ONU 82#1 cannot process the optical signal, communication between the OLT 81#1 and 81#2 and the ONU 82#1 is stopped.

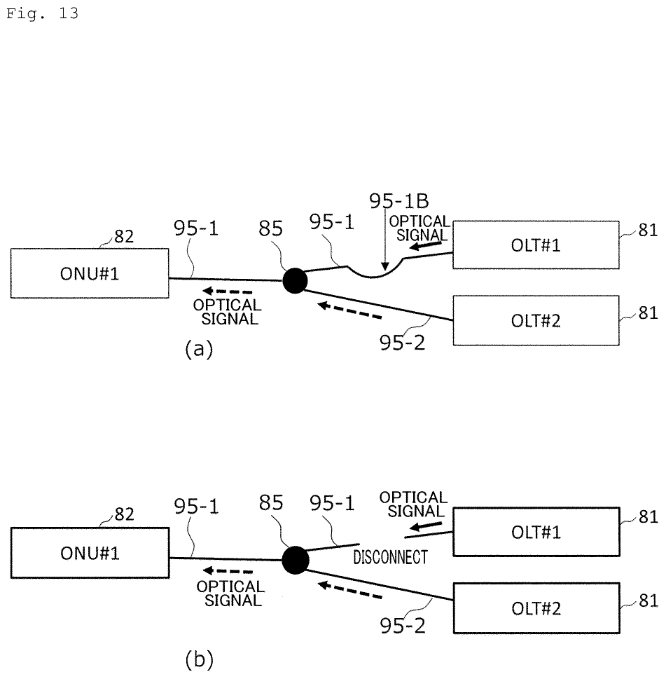

Therefore, the present embodiment is provided with a configuration for preventing an overlap of communication between the OLT 81#1 and the OLT 81#2. Before the cores of the two optical fibers 95-1 and 95-2 are brought close to each other, the optical signal transmitted from the OLT 81#1 is cut off. For example, as shown in FIG. 13(a), the communication from the OLT 81#1 is stopped by giving a bend 95-1B to the optical fiber 95-1 extending from the OLT 81#1. Further, as shown in FIG. 13(b), the optical fiber 95-1 may be cut.

The procedure of the process and the state of the communication stop the communication from the OLT 81#1, for example, before the alignment is performed at the optical coupler 85 disposed at the switching point PS. Thus, since communication from the OLT 81#1 is stopped, two optical signals of the OLT 81#1 and the OLT 81#2 are prevented from reaching the ONU 82#1 in an overlapping manner.

Thereafter, by bringing the two cores 91 of the optical fibers 95-1 and 95-2 in the optical coupler 85 close to each other, the optical signal from the OLT 81#2 side reaches the ONU 82#1 side. An optical signal is also output from the ONU 82#1 and reaches the OLT 81#2. Two-way communication between the OLT 81#2 and the ONU 82#1 is started. The communication of the OLT 81#1 is stopped, and the communication is stopped until the communication of the OLT 81#2 is started.

### Third Embodiment

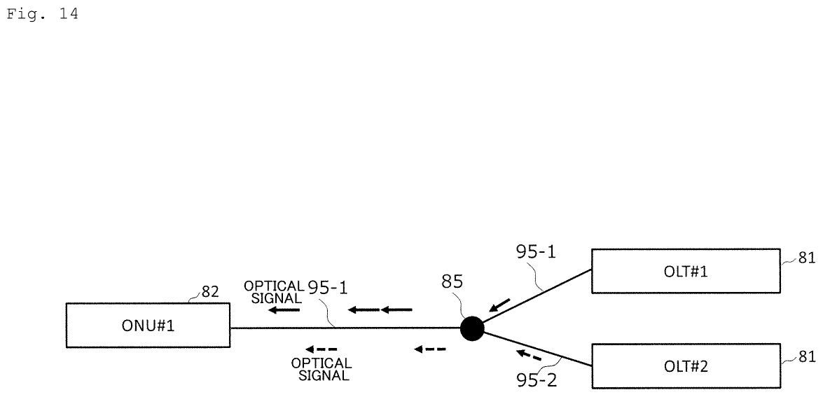

In the second embodiment, the communication of the OLT 81#2 is stopped, but in a third embodiment, a method of not stopping the communication is shown. FIG. 14 shows a device for preventing the communication from being stopped. In order not to stop the communication, optical signals should not reach the ONU 82#1 simultaneously from both the OLT 81#1 and 81#2. Therefore, in the present embodiment, a new function is added to the ONU 82#1. The function is, for example, a time division multiplex communication.

The ONU 82#1, the OLT 81#1, and the OLT 81#2 have a function of controlling so that optical signals are output from the OLT 81#1 and the OLT 81#2 but the optical signals do not overlap. By using the time division multiplex communication, optical signals from the respective OLT 81#1 and 81#2 do not overlap as shown in FIG. 14. If it is found that the optical signals of the OLT 81#1 and the OLT 81#2 alternately come at a predetermined time interval, communication stop in the ONU 82#1 can be prevented.

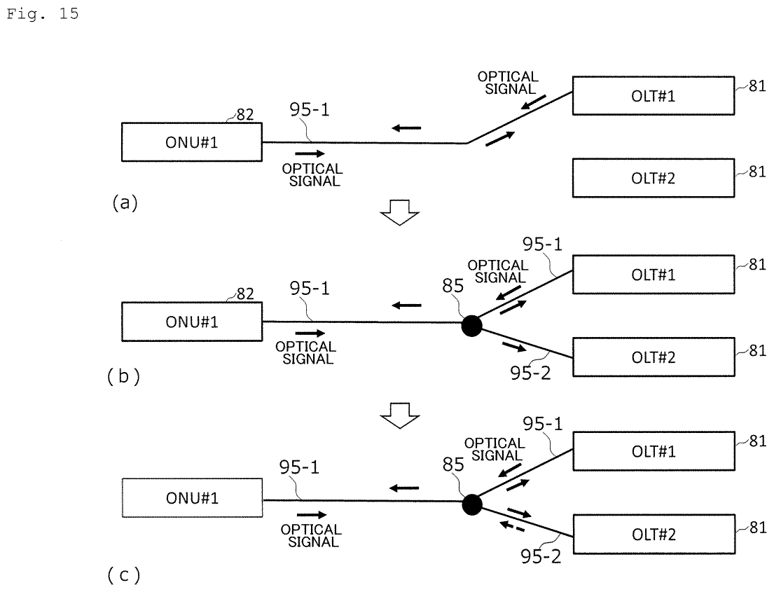

Referring to FIG. 15, timing control of optical signals from the OLT 81#1 and the OLT 81#2 will be described. FIG. 15(a) shows that the OLT 81#1 and the ONU 82#1 communicate with each other before the optical coupler 85 is formed. As a result of the optical coupler 85, the optical signal from the ONU 82#1 is branched and reaches the OLT 81#1 and the OLT 81#2, as shown in FIG. 15(b).

FIG. 15(c) shows that the timing of outputting the optical signal from the OLT 81#2 is after the optical signal from the ONU 82#1 reaches. The optical signal from the ONU 82#1 can include an optical signal for controlling timing of the OLT 81#1 and the OLT 81#2. Therefore, as shown in FIG. 14, it is possible to perform the timing control of the optical signals that are output from the OLT 81#1 and 81#2 of the old communication building and the new communication building.

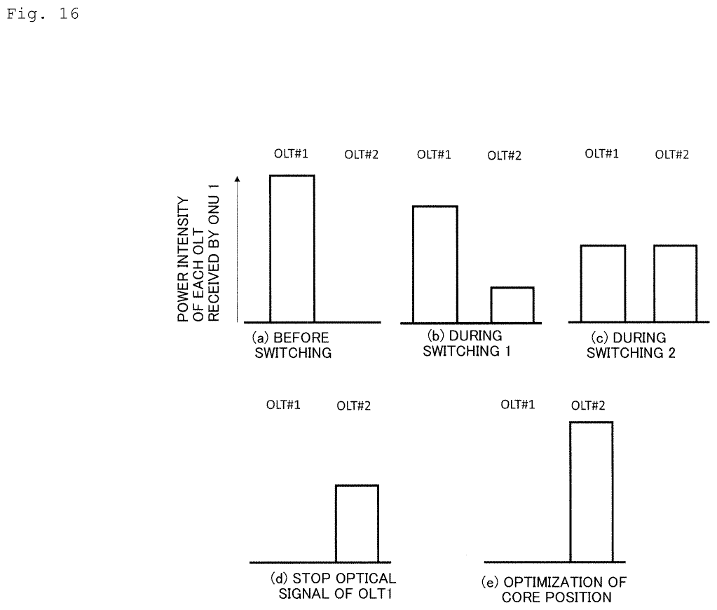

FIG. 16 shows magnitude of power of the OLT 81#1 and the OLT 81#2 received by the ONU 82#1 during switching. The ONU 82#1 includes a function capable of receiving the magnitude of power reaching from each of the OLT 81#1 and 81#2.

Before the optical coupler 85 is manufactured, only the optical signal from the OLT 81#1 installed in the old communication building is used as shown in FIG. 16(a). When the optical coupler 85 is used, the power of the OLT 81#1 is reduced and the power of the OLT 81#2 is increased, as shown in FIG. 16(b).

Further, by adjusting the position of the fiber of the optical coupler 85, as shown in FIG. 16(c), the powers of the OLT 81#1 and the OLT 81#2 become the same. At this time, an instruction of stopping the optical signal of the OLT 81#1 is issued from the ONU 82#1. Although the instruction is divided into two from the ONU 82#1 in the optical coupler 85 provided in the switching point PS, since only the OLT 81#1 follows the instruction, the power supply of the OLT 81#1 is turned off and no optical signal is issued from the OLT 81#1. Therefore, as shown in FIG. 16(d), the power of the OLT 81#1 is eliminated.

Further, by optimizing the positions of the cores 91 of the two optical fibers 95-1 and 95-2 of the optical coupler 85, the optical signal output from the OLT 81#2 can be coupled to the optical fiber 95-1 without causing a loss in the optical coupler 85, as shown in FIG. 16(e). Finally, the OLT 81#1 is removed.

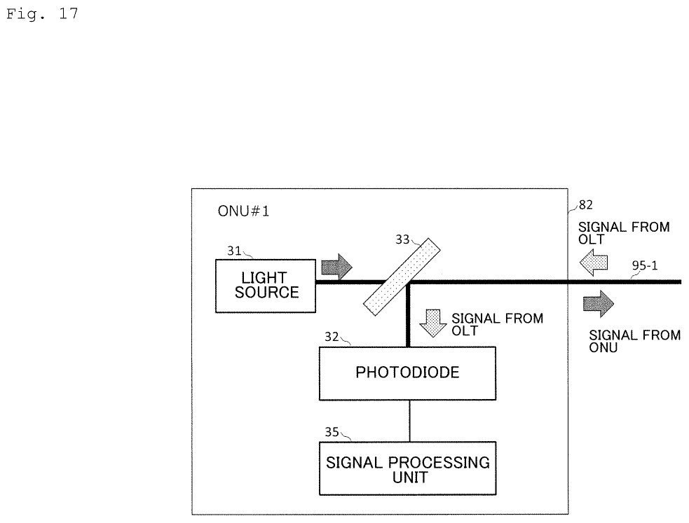

FIG. 17 shows that the ONU 82#1 includes a function capable of receiving the magnitude of the power reaching from each of the OLT 81#1 and 81#2. FIG. 17 shows that the ONU 82 is connected to the optical fiber 95-1, and receives the optical signal from the OLT 81, and the ONU 82 itself outputs the optical signal.

FIG. 17 shows the internal structure of the ONU 82. The ONU 82 includes a light source (laser) 31, a photodiode 32, a wavelength separation filter 33, and a signal processing unit 35. When the optical signal output from the OLT 81 reaches the inside of the ONU 82, the optical signal is reflected by the wavelength separation filter 33 and reaches the photodiode 32. The photodiode 32 is a component for receiving an optical signal from the OLT 81. A light source (laser) 31 is built in the ONU 82, and the optical signal that is output from the ONU 82 is output from the light source 31. The light source 31 and the photodiode 32 are prepared to separate light reception and light emission. Since the light source 31 and the photodiode 32 have different wavelengths, the wavelength separation filter 33 is used. As a specific wavelength, a wavelength of 1,310 nm is applied to the light source 31 and a wavelength of 1,490 nm is applied to the photodiode 32. However, this wavelength can also be changed or changed depending on the system.

Optical signals of the OLT 81#1 and the OLT 81#2 alternately reach the photodiode 32. Since the photodiode 32 can convert an optical signal into an electric signal, the optical signals of the OLT 81#1 and the OLT 81#2 can be naturally converted into electric signals. A MAC address is given to the OLT 81 and the ONU 82 to identify the device. The MAC of the MAC address is an abbreviation of Media Access Control, and an identifier which is used for identification. Since the same number does not exist, the signal processing unit 35 identifies the device by using the MAC address and manages it. Therefore, the OLT 81#1 and the OLT 81#2 have different identifiers.

Even if the optical signal is changed into an electric signal by the photodiode 32, the signal processing unit 35 reads the MAC address. The signal processing unit 35 capable of discriminating the MAC address identification of the OLT 81 is provided in the post-stage of the photodiode 32, and optical signals of the OLT 81#1 and the OLT 81#2 are distributed. That is, the signal processing unit 35 divides the optical signal into the OLT 81#1 and the OLT 81#2, and measures the received power. Thus, when the optical fiber core of the optical coupler 85 is moved, the OLT 81#1 and 81#2 can be distinguished by the signal processing unit 35 provided in the ONU 82, and the light-receiving power can be also displayed.

The signal processing unit 35 compares the power of the first optical signal received from the OLT 81#1 with the power of the second optical signal received from the OLT 81#2, while communicating with the OLT 81#1 and 81#2. When the power of the second optical signal becomes larger than the power of the first optical signal, the signal processing unit 35 transmits an instruction of stopping the transmission of the optical signal. The OLT 81#1 of the OLT 81#1 and 81#2 which receive the instruction stops transmission of the optical signal.

As described above, according to the method of the third embodiment, the old communication building can be switched to the new communication building, without stopping the communication of the OLT 81#1 and 81#2.

### REFERENCE SIGNS LIST

21 Fixing table
22 Pressing table
23 Cutter
24 Electrode rod
31 Light source
32 Photodiode
33 Wavelength separation filter
34 Separation part
35 Signal processing unit
80 Device
81 OLT
82 ONU
83 IDM
84, 84-1, 84-2 Optical cable
85 Optical coupler
91 Core
92 Clad
93, 93-1, 93-2 Glass part
94, 94-1, 94-2 Covering
95, 95-1, 95-2 Optical fiber

1. An optical fiber switching method for switching a communication partner of a first optical communication device connected to a first optical fiber from a second optical communication device connected to the first optical fiber to a third optical communication device connected to a second optical fiber, the method comprising:
polishing each of side surfaces of the first optical fiber and the second optical fiber to a vicinity of a core;
bringing polishing surfaces of the first optical fiber and the second optical fiber close to each other to form an optical coupler that couples the first optical fiber and the second optical fiber; and
switching from the second optical communication device to the third optical communication device using the optical coupler.

2. The optical fiber switching method according to claim 1,
wherein the optical coupler is configured in a state in which the first optical communication device and the second optical communication device maintain communication, and
a coupling condition of light in the optical coupler is adjusted on the basis of optical signals transmitted and received by the first optical communication device and the second optical communication device.

3. The optical fiber switching method according to claim 1,
wherein the optical signal is transmitted from the third optical communication device to the first optical communication device after blocking the optical signal transmitted from the second optical communication device.

4. The optical fiber switching method according to claim 1,
wherein the first optical communication device compares power of a first optical signal received from the second optical communication device with power of a second optical signal received from the third optical communication device while performing communication between the second optical communication device and the third optical communication device,
an instruction of stopping transmission of the optical signal is transmitted when the power of the second optical signal becomes larger than the power of the first optical signal, and the second optical communication device of the second optical communication device and the third optical communication device that have received the instruction stops transmission of the optical signal.

5. The optical fiber switching method according to claim 4,
wherein the first optical communication device performs communication with the second optical communication device and the third optical communication device using time division multiplex communication.

6. An optical communication device which functions as a first optical communication device connected to a second optical communication device by a first optical fiber,
wherein the first optical fiber is connected to a second optical fiber connected to a third optical communication device by an optical coupler,
power of a first optical signal received from the second optical communication device is compared with power of a second optical signal received from the third optical communication device while communication between the second optical communication device and the third optical communication device is performed, and
an instruction of stopping transmission of the optical signal is transmitted when the power of the second optical signal becomes larger than the power of the first optical signal.
